(19) United States
(12) Patent Application Publication
(10) Pub. No.: US 2005/0181268 A1
(43) Pub. Date: Aug. 18, 2005

(54) Fuel cell electrode employing porous graphite film, membrane-electrode assembly and fuel cell

(75) Inventors: Shyusei Ohya, Chiba (JP); Jun Takagi, Chiba (JP)

Correspondence Address: IP GROUP OF DLA PIPER RUDNICK GRAY CARY US LLP, 1650 MARKET ST, SUITE 4900, PHILADELPHIA, PA, 19103, US

(73) Assignee: Ube Industries Ltd. A corporation of Japan, 1978-96, Yamaguchi (JP)

(21) Appl. No.: 10/512,374

(22) PCT Filed: Mar. 31, 2003
(86) PCT No.: PCT/JP03/04092

(30) Foreign Application Priority Data
Apr. 26, 2002 (JP) 2002-127077

(51) Int. Cl. H01M 4/96; H01M 4/90; H01M 4/92; H01M 8/10

(52) U.S. Cl. 429/44; 429/30

(57) ABSTRACT

A fuel cell electrode comprising a structure wherein fine particles of a noble metal or a noble metal element-containing alloy are supported on inner walls of fine pores of a porous graphite film having fine continuous pores, a fuel cell electrode having an ion-conducting electrolyte material coated on the inner walls of continuous pores of the electrode, a membrane-electrode assembly (MEA) comprising the fuel cell electrode assembled onto at least one side of the ion-conducting electrolyte material, and a fuel cell comprising the membrane-electrode assembly as a constituent element thereof. It is thereby possible to obtain, by a simple fabrication process, a fuel cell electrode, membrane-electrode assembly and fuel cell having a support structure which allows effective use of noble metal catalysts, which reliably maintains paths for fuel gas, electrons, protons and water, and which consistently exhibits stable performance over extended periods.

### TECHNICAL FIELD

The present invention relates to a fuel cell electrode employing a porous graphite film, to a membrane-electrode assembly and to a fuel cell.

### BACKGROUND ART

Recent years have seen accelerated development and application of fuel cells. In the case of solid polymer electrolyte type fuel cells, for example, the battery cells are constructed by providing a porous carbon board made of carbon fiber sheets having a thickness of 0.1-0.3 mm, joining to the surfaces thereof gas diffusion electrodes supporting a platinum-based catalyst as the electrode catalyst, on both sides of a polymer solid electrolyte layer, and providing separators made of dense carbon boards with a thickness of 1-3 mm, comprising gas flow channels, on the outer sides of the porous carbon boards on either side.

In the case of phosphoric acid-type fuel cells, the battery cells are constructed by providing a porous carbon boards made of carbon fiber sheets having a thickness of 0.1-0.3 mm, joining to the surfaces thereof gas diffusion electrodes supporting a platinum-based catalyst as the electrode catalyst, on both sides of an electrolyte layer comprising a phosphoric acid support which supports phosphoric acid, and providing separators with a thickness of 1-3 mm, comprising gas flow channels, on the outer sides of the porous carbon boards on either side.

Carbon materials used for noble metal-based catalyst supports are usually powdered materials, typically carbon black, and even the electrodes serving as the structural materials of the reaction chamber of a solid polymer fuel cell are fabricated using noble metal-supporting carbon powder, a binder such as resin, and a solvent paste (for example, Japanese Unexamined Patent Publication No. 5-36418). However, structural control of the fabricated electrodes is limited since powder is used as the starting material, and it has been difficult to form supporting structures that allow effective use of expensive noble metal catalysts.

Moreover, pooling water in the cell during electricity generation produces variation in the internal resistance, and therefore stable operation has required various strategies to be implemented using peripheral members.

It has therefore been proposed to provide a reactive gas and electron conduction path and a water draining channel by combining carbon fiber and carbon particles, but little freedom of design has existed due to the complexity of the fabrication steps and restrictions on pore sizes and thicknesses of the structural materials.

It is known that prolonged use of a fuel cell results in oxidation and corrosion of the carbon base material of the electrodes, and particularly at the sections supporting the noble metal catalyst fine particles. As a result, the catalyst fine particles undergo sintering and increase in size, thereby reducing the apparent activity of the catalyst and constituting a serious problem for practical use.

### DISCLOSURE OF THE INVENTION

It is an object of the present invention to obtain, by a simple fabrication process, a fuel cell electrode, membrane-electrode assembly and fuel cell having a supporting structure which allows effective use of noble metal catalysts, which reliably maintains paths for fuel gas, electrons, protons and water, and which consistently exhibits stable performance over extended periods.

The invention relates to a fuel cell electrode comprising a structure wherein fine particles of a noble metal or a noble metal element-containing alloy are supported on inner walls of fine pores of a porous graphite film having fine continuous pores.

The invention further relates to a fuel cell electrode wherein an ion-conducting electrolyte material is coated on the inner walls of continuous pores of the electrode.

The invention still further relates to a membrane-electrode assembly (MEA) comprising the aforementioned fuel cell electrode assembled onto at least one side of the ion-conducting electrolyte material.

The invention yet further relates to a fuel cell comprising the aforementioned membrane-electrode assembly as a constituent element thereof.

### BRIEF DESCRIPTION OF THE DRAWINGS

FIG. 1 is a schematic view of a porous structure having fine continuous pores.

FIG. 2 shows the reproducibility of current density-voltage curves for a fuel cell employing a porous graphite electrode according to Example 2 for both electrodes.

FIG. 3 shows the serial resistance component during constant current operation of a fuel cell employing a porous graphite electrode according to Example 2 for both electrodes.

FIG. 4 shows the reproducibility of current density-voltage curves for a fuel cell employing an electrode made of catalyst-supporting carbon powder and carbon paper, according to Comparative Example 2, for both electrodes.

FIG. 5 shows the serial resistance component during constant current operation of a fuel cell employing an electrode made of catalyst-supporting carbon powder and carbon paper, according to Comparative Example 2, for both electrodes.

### BEST MODES FOR CARRYING OUT THE INVENTION

The following are the preferred modes of the invention.

1) A fuel cell electrode comprising fine particles of a noble metal or noble metal element-containing alloy are finely dispersed in the inner walls of the fine pores of a porous graphite film having fine continuous pores.

2) The aforementioned fuel cell electrode wherein the fine particles of a noble metal or noble metal element-containing alloy are fine particles of a noble metal or noble metal element-containing alloy which are supported on carbon fine particles.

3) The aforementioned fuel cell electrode wherein the porous graphite film has a mean pore size of 0.05-10 μm and a porosity of 10-85%.

4) The aforementioned fuel cell electrode wherein the porous graphite film has a thickness of 3-100 μm.

5) The aforementioned fuel cell electrode wherein the noble metal or noble metal element-containing alloy is supported at a proportion of 0.1-60 mass % in the electrode.

6) The aforementioned membrane-electrode assembly wherein the ion-conducting electrolyte material is a polymer electrolyte film.

The porous graphite film of the invention has a porous structure with fine continuous pores, preferably with a mean pore size of 0.05-10 μm and a porosity of 10-85%, and particularly preferably has a thickness of 3-100 μm.

In particular, the porous graphite film may comprise a carbon film structure having a porous structure with fine continuous pores, usually with a crystallinity of 60% or greater, and with a smooth surface except for the open pores.

Throughout the present specification, “a porous structure with fine continuous pores” refers to “open pores” wherein the pores run continuously as passageways from any surface to the other surface, and wherein the sections between the adjacent pores form a wall structure and the pores extend in a non-linear crooked fashion.

In other words, the porous graphite film may have a structure such that gas flowing through it is directed through the passage-like pores extending in a non-linear fashion and exits in a non-linear fashion, so that no shorting path occurs. Also, the surface of the porous graphite film having a porous structure according to the invention may be smooth at the sections other than the open pores formed from the film interior to the surface, and therefore when it is laminated with a porous carbon structural body and/or separator, a surface contact may be formed between the other layer and the smooth surface.

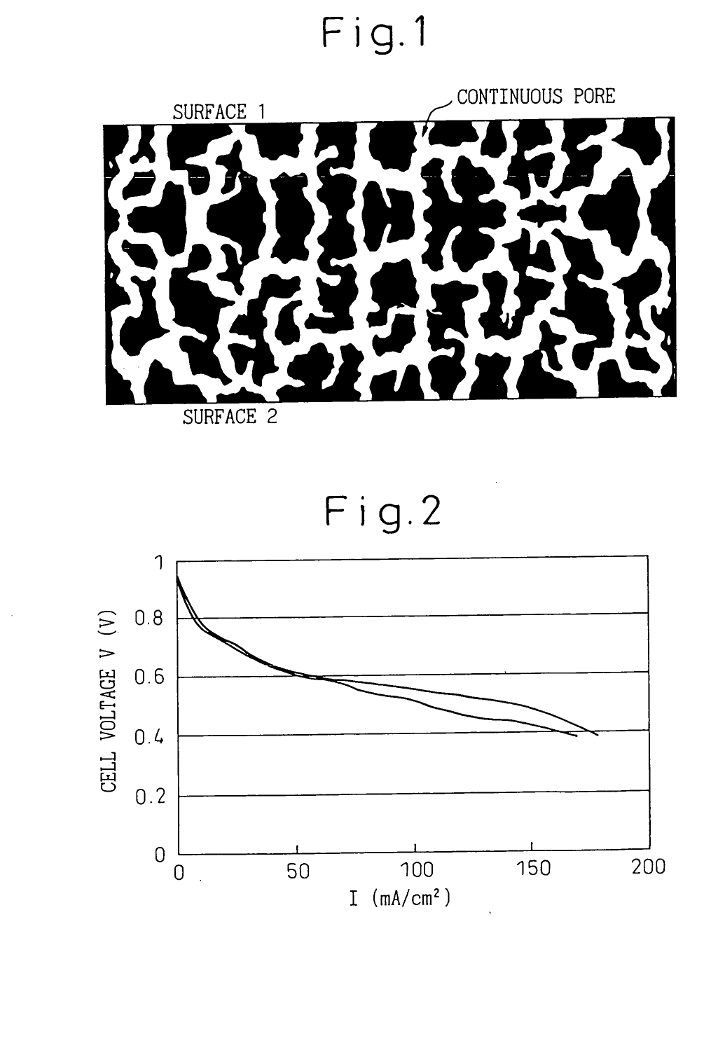

The porous structure and surface smoothness will now be explained in greater detail with reference to FIG. 1 which is a schematic cross-sectional view of an example of a carbon film structural body having a porous structure as a fuel cell electrode material according to the invention. Because the carbon film structural body of the porous graphite film of the invention has a smooth surface except for the open pores, a surface contact is formed at the interface upon formation of a laminate.

The porous graphite film of the invention has fine continuous pores, and a crystallinity (graphitization) of 60% or greater, and preferably 90% or greater. A crystallinity of 90% or greater and a crystal size [(002) face] of at least 150 Å is preferred for improved electron conduction and enhanced film toughness. The mean pore size of the continuous pores is 0.05-10 μm. A mean pore size of less than 0.05 μm is not preferred as this may hinder drainage of water during electricity generation by the fuel cell. A mean pore size of greater than 10 μm is also not preferred since it may become difficult to evenly distribute the supplied fuel gas in the planar direction. The mean pore size of the porous graphite film of the invention may be adjusted by the porosity of the polyimide film or the heating temperature during the carbonization or graphitization. At least a portion of the pores must be continuous.

A porous graphite film with fine continuous pores according to the invention may be obtained by preferably graphitizing a porous film made of a highly heat resistant resin with fine continuous pores by heating it at 2600-3500° C. in an anaerobic atmosphere. More preferably, elemental boron may be incorporated into the molecular structure of the highly heat resistant resin or a boron compound added at one of the earlier stages prior to the graphitization step, to accelerate crystallization to graphite and increase the crystallinity and crystallite size.

The porous film made of a highly heat resistant resin with fine continuous pores may be a porous film composed of a highly heat resistant resin such as polyimide, polyamideimide or aromatic polyamide, and preferably a polyimide porous film obtained using as the starting material a polyimide precursor (also known as polyamic acid) solution wherein tetracarboxylic dianhydride and a diamine are polymerized in an organic solvent.

The porous polyimide film used as a representative example of a porous film of a highly heat resistant resin according to the invention may be produced by the following method. Other highly heat resistant resin porous films may also be obtained in a similar manner from acid and amine components. The cast polyimide precursor is contacted with a solidifying solvent through a solvent exchange rate-adjusting material to precipitate and form pores in the polyimide precursor, and then the pore-formed polyimide precursor film is subjected to thermal or chemical imidization to produce a porous polyimide film.

The “polyimide precursor” is a polyamic acid (or partially imidized compound) obtained by polymerization of a preferably aromatic monomer comprising a tetracarboxylic acid component and diamine component, and it may be converted to a polyimide by heat treatment either in the absence or presence of a chemical imidizing agent.

The tetracarboxylic acid and diamine components may be polymerized by dissolution in roughly equimolar amounts in an organic solvent to obtain an organic solvent solution of a polyimide precursor with an inherent viscosity (30° C., 0.5 g/100 mL NMP) of 0.3 or greater and especially 2.2 or greater, and particularly an organic solvent solution of a polyimide precursor having a polyimide precursor concentration of no greater than 12 mass % and a solution viscosity of 400 poise or greater, and the polymer component may be precipitated by solvent exchange-induced phase separation to form pores therein. The solvent exchange induction is preferably carried out while using a solvent exchange rate-adjusting material to avoid direct contact between the solidifying solvent and the polyimide precursor organic solvent solution.

The tetracarboxylic acid component is preferably 3,3′,4,4′-biphenyltetracarboxylic dianhydride (hereinafter may be abbreviated as s-BPDA), but it may alternatively be 2,3,3′, 4′-biphenyltetracarboxylic dianhydride (hereinafter may be abbreviated as a-BPDA) or 2,3,3′,4′- or 3,3′,4,4′-biphenyltetracarboxylic acid or a salt or esterified derivative of 2,3,3′,4′- or 3,3′,4,4′-biphenyltetracarboxylic acid. The biphenyltetracarboxylic acid component may also be a mixture of the aforementioned biphenyltetracarboxylic acids.

The diamine component is preferably, for example, p-phenylenediamine (hereinafter may be abbreviated as PPD), 4,4′-diaminodiphenylether (hereinafter may be abbreviated as DADE), 3,3′-dimethyl-4,4′-diaminodiphenylether, 3,3′-diethoxy-4,4′-diaminodiphenylether, or the like.

A polyimide porous film obtained from a combination of s-BPDA and PPD is particularly preferred for use to achieve a higher graphitization degree and crystallite size, because of its high in-plane orientation and facile graphite crystal growth.

The organic solvent used as the solvent for the polyimide precursor may be para-chlorophenol, N-methyl-2-pyrrolidone (NMP), pyridine, N,N-dimethylacetamide, N,N-dimethylformamide, dimethylsulfoxide, tetramethylurea, phenol, cresol or the like.

The polyimide precursor solution is cast into a film form, and then a solvent exchange rate-adjusting material is situated on at least one side thereof to form a laminated film and the coagulating solvent is contacted therewith through the solvent exchange rate-adjusting material to precipitate and form pores in the polyimide precursor.

The solvent exchange rate-adjusting material is preferably one having a permeability which allows permeation of the polyimide precursor solvent and coagulating solvent at an appropriate rate when the multilayer film is contacted with the coagulating solvent to precipitate the polyimide precursor. The film thickness of the solvent exchange rate-adjusting material may be 5-500 μm and preferably 10-100 μm, and preferably has pores with a mean size of 0.01-10 μm and especially 0.02-2 μm dispersed at an adequate density and continuous in the film cross-sectional direction. If the film thickness of the solvent exchange rate-adjusting material is below the aforementioned range, the solvent exchange rate may be too high, not only resulting in formation of a dense layer on the precipitated polyimide precursor surface, but also possibly leading to wrinkles upon contact with the coagulating solvent, whereas if it is above the aforementioned range, the solvent exchange rate may be too low, resulting in a non-uniform pore structure inside the polyimide precursor.

As solvent exchange rate-adjusting materials there may be used, specifically, nonwoven fabrics or porous films composed of polyolefins such as polyethylene and polypropylene, or cellulose, polyfluoroethylene and the like, and polyolefin fine porous films are particularly preferred for achieving excellent smoothness of the resultant polyimide porous film surface.

The cast polyimide precursor laminated with the solvent exchange rate-adjusting material is contacted with the coagulating solvent through the solvent exchange rate-adjusting material to precipitate and form pores in the polyimide precursor. The coagulating solvent for the polyimide precursor may be a non-solvent for the polyimide precursor, for example an alcohol such as ethanol or methanol, or acetone, water or the like, or a mixed solvent comprising 99.9-50 mass % of a non-solvent and 0.1-50 mass % of a solvent for the polyimide precursor. There are no particular restrictions on the combination of a non-solvent and solvent, but a solvent mixture comprising the non-solvent and solvent is preferably used as the coagulating solvent since it gives a precipitated polyimide precursor with a uniform porous structure.

Alternatively, as described in Japanese Patent Application No. 11-265347, the polyimide porous film with fine continuous pores may be produced using a solvent mixture comprising non-solvents having miscibility parameters within specified ranges. This method may involve, for example, casting into a film form a solution comprising 0.3-60 mass % of the polyimide precursor and 99.7-40 mass % of the solvent and exposing it to vapor of a non-solvent for the polyimide precursor, subsequently immersing it or contacting it with the coagulating solvent to form a porous film of the polyimide precursor, and then subjecting the resultant polyimide precursor porous film to heat treatment or chemical treatment to obtain a polyimide porous film.

The exposure to the non-solvent vapor may be accomplished by a method of preparing a gas containing the non-solvent for the polyimide precursor, for example an alcohol such as ethanol or methanol, or acetone, water or the like, as a gas phase, and blowing the gas onto the polyimide precursor solution surface to incorporate the non-solvent vapor into the precursor solution, or a method wherein the polyimide precursor solution is held in a treatment tank filled with the gas, or passed through it on a belt, to condense the non-solvent vapor onto the precursor solution.

Continuing the step of exposure to the non-solvent vapor to about 0.1 mole or greater of non-solvent vapor per square meter of precursor solution surface is preferred for inhibiting formation of a dense layer. There is no particular upper limit on the time for exposure to the non-solvent vapor, but in order to obtain a uniform porous structure the exposure is preferably terminated just before the amount of non-solvent condensed on the precursor solution surface increases causing precipitation of the precursor and clouding of the precursor solution.

The temperature of the precursor solution in the non-solvent vapor exposure step may be room temperature, but this is not restrictive so long as the conditions are such as to allow condensation of the non-solvent vapor on the polyimide precursor solution surface. The atmosphere of the precursor solution during the non-solvent vapor exposure step may be air at atmospheric pressure, but this is also not restrictive so long as the conditions are such as to allow condensation of the non-solvent vapor on the polyimide precursor solution surface.

The film of the polyimide precursor solution treated in the non-solvent vapor exposure step is contacted with the coagulating solvent to precipitate and form pores in the polyimide precursor. The coagulating solvent for the polyimide precursor may be a non-solvent for the polyimide precursor, for example an alcohol such as ethanol or methanol, or acetone, water or the like, or a mixed solvent comprising 99.9-50 mass % of a non-solvent and 0.1-50 mass % of a solvent for the polyimide precursor.

The film of the polyimide precursor in which pores have been formed by one of the methods described above is then made into a polyimide porous film by heat treatment or chemical treatment. Heat treatment of the polyimide precursor film is preferably carried out at 280-500° C. in air for 5-60 minutes, with the polyimide precursor porous film anchored with a pin, chuck or pinch roll to prevent thermal shrinkage.

The polyimide porous film produced in this manner has a porosity of 30-85% and preferably 40-70%, and a mean pore size of 0.05-10 μm, preferably 0.05-5 μm, most preferably 0.1-1 μm and no greater than 10 μm, although this will differ somewhat depending on the selected production conditions. If the porosity is too low, the effective area of the carbonized film may be too small and the permeability and penetrability performance of the solution will not be readily exhibited, especially if it is viscous. If the porosity is too high, the mechanical strength may be undesirably reduced.

In order to obtain a porous graphitized film according to the invention, a porous polyimide film composition containing, as necessary, a boron-based compound added to the porous polyimide film, is heated in an anaerobic atmosphere preferably at a temperature of 2600-3500° C. for graphitization. Here, the heating is preferably accompanied by pressurization. If the pressure is isotropically applied, the entire sample will contract isotropically while retaining its initial shape, since the pressure will isotropically follow the condensation accompanying crystallization, and this is therefore preferred for fabrication of a graphite structure which is to reflect the shape of the precursor film, for example, a porous body or complex shape.

An anaerobic atmosphere for graphitization must not have oxidizing activity such as oxygen or the like, and gases such argon and helium are therefore suitable as the anaerobic gas.

The graphitization of the precursor is preferably carried out in a stream of an inert gas to allow smooth elimination of decomposition products and to prevent reprecipitation of the vaporized decomposition products. The first stage is therefore conducted by calcining in an inert gas stream at a temperature in the range of 1000-1500° C.

This temperature range is preferred for gradual carbonization of the porous polyimide film, since sudden escape of the decomposition products results in elimination of carbon, a reduced carbonization yield and more defects in the structure. For this reason, the temperature elevating rate is preferably no greater than 20° C./min and especially about 0.5-10° C./min as a sufficiently slow and preferred temperature elevating rate.

If calcining at a temperature higher than 1000-1500° C. has eliminated the vapor products by thermal decomposition, a second stage of carbonization is carried out in a temperature range of 2600-3500° C. Here, a boron-based compound may be added to the carbonized film using a solvent, for example, and heating performed to a temperature which accelerates graphitization. The heating may also be performed at a temperature which accelerates graphitization while applying pressure either in the direction vertical to the film surface, or isotropically.

The graphitization is preferably conducted while applying pressure with the heating as above, as this will facilitate orientation of the graphite crystal precursor in the carbonized film and give a high-strength graphitized product. The presence of the boron-based compound will also result in a graphite structure with high crystallinity. Isotropic pressure is important for the product to reflect the initial shape of the porous film. A preferred method of applying pressure to the film surface involves heating while it is sandwiched between heat resistant porous plates or film sheets, in order to adjust the carbonized and graphitized film. It may be sandwiched between a carbon board and a graphite film, for example.

According to the method described above, it is possible to produce a highly crystalline porous graphite film by heating a porous polyimide film having continuous pores with a mean pore size of 0.05-10 μm at 2600-3500° C. in an anaerobic atmosphere.

The porous graphite film of the invention has a crystallinity of 60% or greater, and preferably 90% or greater, and a large crystallite size which is preferably at least 100 Å (especially 100-1000 Å) in the (002) face direction and at least 75 Å (especially 75-500 Å) in the (101) face direction.

The porosity of the carbon film structural body of the porous graphite film is 10-85% and preferably 30-70%. If the porosity is below this range, the gas outflow is reduced and the ability to eliminate water is insufficient. If the porosity is above this range, the mechanical strength of the electrode may be reduced to an undesirable degree.

The carbon film structural body of the porous graphite film also preferably has a graphitization degree of 60% or greater and especially 90% or greater. A graphitization degree of 90% or greater is preferred for high mechanical strength of the electrode and enhanced flexibility, as well as improved electrical and thermal conductivity.

The fuel cell electrode of the invention is obtained by supporting fine particles of a noble metal or a noble metal element-containing alloy (hereinafter also referred to simply as “noble metal fine particles”) on the inner walls of the fine pores of a porous graphite film having fine continuous pores and having a smooth surface at the sections other than the open pores.

As noble metals and noble metal element-containing alloys there may be mentioned any one selected from the group consisting of palladium, platinum, rhodium, ruthenium and iridium, as well as alloys containing these noble metal elements and their various combinations or combinations with other transition metals.

The mean particle size of the noble metal fine particles is preferably no greater than 5 nm, and the maximum particle size is preferably no greater than 15 nm.

According to the invention, the amount of noble metal particles supported will differ depending on the characteristics required for the fuel cell fabricated using the electrode, and on the electrode film thickness and specific surface area, but in general it is preferably between 0.02 mg/cm² and 0.45 mg/cm², especially no greater than 0.35 mg/cm² and more preferably no greater than 0.25 mg/cm² on the positive pole, and between 0.01 mg/cm² and 0.25 mg/cm² on the negative pole.

According to the invention, a polymer electrolyte or oligomer electrolyte (ionomer) is preferably used together with the noble metal fine particles.

The polymer electrolyte or oligomer electrolyte is preferably used at between 0.1 mg/cm² and 10 mg/cm², preferably no greater than 5 mg/cm² and more preferably no greater than 3 mg/cm², per unit area of the electrode.

The fuel cell electrode of the invention may be obtained by supporting the noble metal fine particles on the inner wall of the fine pores of the porous graphite film, by a known supporting method using a noble metal precursor solution. Preferably, it is obtained by evenly dispersing a catalyst composition comprising the noble metal fine particles in a solvent and coating and drying the dispersion over the entire surface or in a prescribed shape on one side of the porous graphite film, to fill the noble metal fine particles supported on the carbon fine particles into the fine pores. A polymer electrolyte or oligomer electrolyte (ionomer) may also be dispersed in the solvent together with the noble metal fine particles.

The noble metal fine particles supported on the walls of the fine pores of the graphite film are preferably finely dispersed without aggregate. The method of fine dispersion may be a publicly known method for finely dispersing and supporting a noble metal catalyst onto carbon particles.

For example, in the case of a supporting method using a noble metal precursor solution, a solution diluted to an appropriate concentration may be used for loading over a few times, or the type of solvent and noble metal compound solute for the solution may be appropriately selected, while setting suitable solvent vaporizing conditions in the step of drying the solvent, to thereby control aggregation of the noble metal precursor. Reduction without aggregation may thus be achieved for fine dispersion of the noble metal fine particles.

In a method of coating the porous graphite film with a catalyst composition in which the noble metal fine particles, and optionally a polymer electrolyte, are evenly dispersed in a solvent, aggregation of the noble metal fine particles may be inhibited by, for example, coating the base material over a few times, appropriately selecting the type of solvent for the solution, stirring the mixed solution with ultrasonic waves or the like to form a homogeneous mixture before coating onto the base material, and setting appropriate solvent vaporizing conditions in the step of drying the mixed solution after coating. After coating and drying, it is effective to provide an overcoat of a solvent such as acetone or the like by several applications.

According to the invention, the method described above may be used to fill part or all of the thickness of the porous graphite film with the catalyst composition.

A method of fabricating an electrode using the catalyst composition will now be explained.

As polymer electrolytes or oligomer electrolytes there may be mentioned polymers or oligomers with ion conductivity, or polymers or oligomers that produce polymers or oligomers with ion conductivity upon reaction with acids or bases.

As suitable polymer electrolytes or oligomer electrolytes there may be mentioned fluoropolymers with pendant ion-exchange groups such as sulfonic acid in protonated or salt form, and particularly perfluorosulfonic acid polymers such as Nafion™ (DuPont), perfluorosulfonic acid oligomers and sulfonated polyimides, sulfonated oligomers and the like.

The polymer electrolyte or oligomer electrolyte must be essentially insoluble in water at temperatures of up to 100° C.

As appropriate solvents to be used for production of catalyst composition ink there may be mentioned polar solvents such as C₁₋₆ alcohols, glycerin, ethylene carbonate, propylene carbonate, butyl carbonate, ethylene carbamate, propylene carbamate, butylene carbamate, acetone, acetonitrile, dimethylformamide, dimethylacetamide, 1-methyl-2-pyrrolidone, difluorobenzene and sulfolane. The organic solvent may be used alone or in admixture with water.

The organic solvent is preferably used in an amount of at least 1%, especially at least 10% and no greater than 70% based on the weight of the composition. The proportion in a mixture of the organic solvent with water is preferably a organic solvent:water ratio in the range of 10:1-1:5 based on volume.

The membrane-electrode assembly of the invention is obtained by hot pressing a fuel cell electrode obtained in the manner described above onto both sides of a polymer electrolyte film, for example, at a temperature of 120-150° C. and a pressure of about 1-100 kg/cm² for approximately 0.1-30 minutes.

As polymer electrolyte films there may be mentioned the polymers or oligomers with ion conductivity, or polymers or oligomers that produce polymers or oligomers with ion conductivity upon reaction with acids or bases, referred to above.

Since one side of the electrode must have satisfactory adhesion with the electrolyte film, it is preferably coated with the polymer electrolyte or oligomer electrolyte beforehand. Also, since the opposite side must contact with a gas diffusing layer or distribution function-equipped separator to form an electron conduction path, it is preferably not coated with the polymer electrolyte or oligomer electrolyte. An electrode of this form can be accomplished, for example, by actively utilizing the phenomenon whereby the solution interface recedes in the direction of solvent vaporization of the catalyst composition ink.

The membrane-electrode assembly of the invention has numerous fine continuous pores and is therefore suitable as a structural body in a high-performance fuel cell providing a widely and evenly dispersed reaction field for the cell reaction.

Moreover, the graphite structure provides high water repellency and thus allows spontaneous drainage of water pooling in the pores at the reaction sites during electric generation at both electrodes, in order to permit stable operation of the fuel cell.

In addition, since graphite is more resistant to oxidation and reduction than amorphous carbon, it is not readily corroded even by noble metal catalysts with high oxidation-reduction potential, does not erode excessively in the acidic environment of the fuel cell, and can inhibit sintering of the catalytic noble metal fine particles, thereby providing a major advantage in terms of durability.

The fuel cell of the invention has a membrane-electrode assembly as a constituent element thereof, and it is obtained, for example, by providing a pair of separators on both sides of the electrodes either directly or via gas diffusion layers, and situating seals between each pair of separators to prevent reactive gas leakage.

The invention will now be explained in greater detail through examples, with the understanding that the invention is in no way restricted by the examples. In each of the examples, the air permeability, porosity, mean pore size and crystallinity were determined by the following methods.

1. Air Permeability

This was measured according to JIS P8117. A Type B Gurley densometer (product of Toyo Seiki) was used as the measuring instrument. A test strip was clamped over the orifice having a 28.6 mm diameter and 645 mm² area. The air in the cylinder was pushed out of the cylinder through the orifice by a weight of 567 g in the cylinder. The time required for 100 cc of air to pass through was measured as the air permeability (Gurley value).

2. Porosity

The apparent density of a porous film cut to a prescribed size was calculated from the film thickness, area and weight, and the porosity was determined from formula (1) below. In formula 1, S is the area of the porous film, d is the film thickness, w is the measured weight, and D and d are the densities of the polyimide and graphite, respectively. The polyimide density was 1340 kg/m³ and the density of the graphite was 1810 kg/m³.
Porosity (%)=100−100×(W/D)/(S×d)

3. Mean Pore Size

The pore areas of 50 or more open pores were measured from a scanning electron microscope photograph of the porous film surfaces (total pores of 100 or more), and the mean diameter, assuming a round pore shape, was calculated using the following equation based on the average value for the pore areas. Sa in the equation represents the average value for the pore areas.
Mean pore size=2×(Sa/π)^{1/2}

4. Crystallinity

The crystallinity of the graphite film was determined by grinding the graphite film into powder, measuring the X-ray diffraction and measuring the crystallinity by the Ruland method.

5. Lattice Constant

The graphite film was ground into powder, the X-ray diffraction was measured, and the lattice constant of the graphite crystals was determined from the diffraction lines in the (002) and (101) faces.

6. Crystallite Size

The graphite film was ground into powder, the X-ray diffraction was measured, and the crystallite size was determined by the Sheller formula based on the half-widths of the peaks for the (002) and (101) faces.

7. Fuel Cell Performance Evaluation

Using a fuel cell electron load device, electricity was generated with a fuel gas pressure of 0.1 MPa in the cell and a cell temperature of 80° C., by humidification of the fuel gas through a bubbler at 70° C., and the current-voltage characteristic was measured.

8. Measurement of Serial Resistance Component of Fuel Cell

The fuel cell was operated at a constant current of 40 mA, the current was instantaneously cut off, the voltage at that moment was analyzed by incorporation in a time waveform, and the serial resistance component was determined.

### REFERENCE EXAMPLE 1

Production of Precursor Porous Polyimide Film

s-BPDA as the tetracarboxylic acid component and PPD as the diamine component were dissolved in NMP to a total monomer component weight of 9 mass %, and polymerization was conducted to obtain a polyimide precursor solution with an inherent viscosity (30° C., 0.5 g/100 mL NMP) of 3.3.

The obtained polyimide precursor solution was cast to a thickness of about 120 μm, and the surface was covered with a polyolefin fine porous film (UPORE UP2105, Ube Industries, Ltd.) having an air permeability of 500 sec/100 cc as a solvent exchange rate-adjusting material to prevent wrinkles. The laminate was immersed for 8 minutes in a coagulating solution comprising a thorough mixture of methanol and isopropanol at a volume ratio of 1:1, and the polyimide precursor was precipitated and rendered porous by solvent exchange through the solvent exchange rate-adjusting material. After immersing the precipitated polyimide precursor porous film in water for 15 minutes, it was released from the base and solvent exchange rate-adjusting material and subjected to heat treatment at 430° C. for 20 minutes in air while anchored on a pin tenter. The imidization rate of the polyimide porous film was 80%, and it had continuous pores in the direction of the film cross-section.

The following are the results of measuring the film thickness, air permeability, porosity and mean pore size of the obtained polyimide porous film.

Measurement results:
Film thickness: 30 μm
Air permeability: 320 sec/ml
Porosity: 43%
Mean pore size: 0.16 μm

Fabrication of Porous Graphite Film

The aforementioned porous polyimide film was carbonized at a temperature of 1400° C. under a nitrogen gas stream, to obtain a porous carbon film with a graphitization degree of 18%, a film thickness of 21 μm, an air permeability of 380 sec/100 ml, a porosity of 40% and a mean pore size of 0.14 μm. The porous carbon film was sandwiched between gas permeable carbon sheets in an argon gas atmosphere, and the temperature was increased to 1200° C. at a temperature elevating rate of 10° C./min and to 2800° C. at a temperature elevating rate of 5° C./min, and held at that temperature for 120 minutes. The obtained porous graphite film had slightly smaller pores than before carbonization, with a crystallinity of at least 90% and a mean pore size of 0.10 μm. The lattice constant was 2.53 Å on the (a) axis and 6.68 Å on the (c) axis, and the crystallite size was 180 Å at the (002) face and 90 Å at the (101) face. The presence of fine continuous pores was confirmed by scanning electron microscopy and permeation of methanol.

### EXAMPLE 1

After stirring and mixing 10 mg of platinum fine powder (product of Johnson Matthey, U.S.) in 10 ml of acetone while cooling in an ice bath, the mixture was irradiated with ultrasonic waves for 1 hour to obtain an acetone mixture containing a fine powder dispersion.

The platinum fine powder dispersion composition was coated and dried onto one side of the aforementioned porous graphite film cut to a 5 cm square, to support the platinum fine particles inside the pores, thereby obtaining a gas diffusion electrode.

The platinum content of the gas diffusion electrode was measured by ICP emission spectrometry and found to be 0.14 mg/cm² per unit area of the electrode.

### COMPARATIVE EXAMPLE 1

After stirring and mixing in an ice bath 100 mg of a platinum-supporting carbon catalyst (20 mass % platinum, product of Johnson Matthey, U.S.) with 10 ml of water, 20 ml of isopropanol and 0.05 g of a commercially available Nafion 5012 solution (5 mass %, DuPont) and allowing the mixture to stand for a prescribed period, it was irradiated with ultrasonic waves for 1 hour to disperse the particles.

The catalyst dispersion composition obtained in this manner was coated and dried onto one side of carbon paper (Toray) cut to a 5 cm square to obtain a gas diffusion electrode.

The platinum content of the gas diffusion electrode was measured by ICP emission spectrometry and found to be 0.9 mg/cm² per unit area of the electrode.

### EXAMPLE 2

Fabrication of Membrane-Electrode Assembly (MEA) and Fuel Cell

A Nafion 1135 membrane (DuPont), as a polymer electrode membrane, was heat treated in a 3% aqueous hydrogen peroxide solution and then in a 3% aqueous sulfuric acid solution.

Separately, a commercially available Nafion 5012 solution (5 mass %, DuPont) was dried to solidity to prepare a Nafion solid, and 10 mg of the solid was dissolved in 200 mg of a mixed solvent of dimethylformamide/water at a weight ratio of 1:1 and then diluted with 10 g of acetone to obtain a Nafion coating solution. The solution was coated and dried onto one side of the gas diffusion electrode obtained in Example 1 to cover the inner pore walls of the catalyst-supporting electrode with an ultrathin polymer electrolyte layer. Two gas diffusion electrodes obtained in this manner were situated on both sides of the Nafion 1135 polymer electrolyte membrane and contact bonded therewith using a hot press at 135° C., 5 kg/cm² for 10-12 minutes to obtain an MEA.

The MEA was sandwiched between separator plates by a common procedure to fabricate a fuel cell.

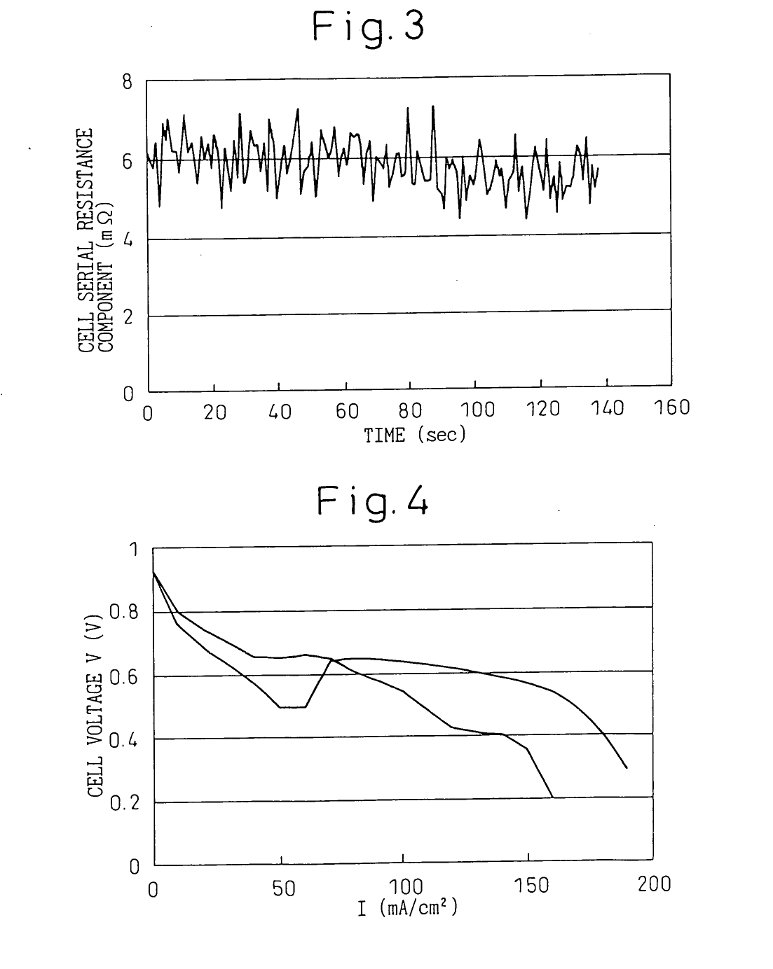

Fuel gas (hydrogen) was supplied to the fuel electrode of the resultant fuel cell, air was supplied to the air electrode at an internal cell pressure of about 0.1 MPa, the cell temperature was adjusted to 80° C. and the fuel gas was humidified through a 70° C. bubbler for an electricity generating test. Upon measuring the current-voltage characteristic for 1 hour while maintaining a constant current, the current-voltage characteristic demonstrated satisfactory reproducibility over an extended period (FIG. 2). The serial resistance component in the cell during constant current operation was also a low value, and operation proceeded with a roughly consistent value (FIG. 3).

### COMPARATIVE EXAMPLE 2

An MEA was obtained in the same manner as Example 2 except for using the gas diffusion electrode obtained in Comparative Example 1 for both electrodes, and this MEA was used to fabricate a fuel cell in the same manner as Example 2.

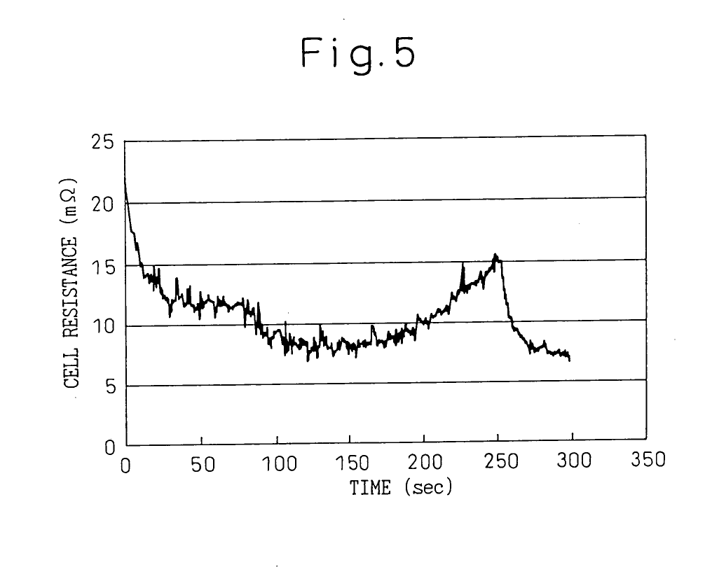

Fuel gas (hydrogen) was supplied to the fuel electrode of the fuel cell, air was supplied to the air electrode at an internal cell pressure of about 0.1 MPa, the cell temperature was adjusted to 80° C. and the fuel gas was humidified through a 70° C. bubbler. This resulted in large variation in the current/voltage relationship (FIG. 4), with unstable operation and serial resistance component magnitude (FIG. 5). The absolute value of the serial resistance component was also large.

### INDUSTRIAL APPLICABILITY

According to the present invention, it is possible to easily obtain an electrode having a prescribed amount of noble metal-based fine particles supported on a porous graphite film, to allow effective utilization of noble metal-based catalysts.

According to the invention it is also possible to obtain an electrode which ensures an elimination path for fuel gas, electrons, protons and water, while also ensuring stable operation of the fuel cell, since the water repellency of the graphite base material prevents blockage by water produced around the catalyst fine particles.

Moreover, the invention allows fabrication of a fuel cell with extremely low internal resistance.

The invention can also provide a fuel cell electrode and membrane-electrode assembly by simple fabrication steps.

1. A fuel cell electrode comprising a structure wherein fine particles of a noble metal or a noble metal element-containing alloy are supported on inner walls of fine pores of a porous graphite film having fine continuous pores.

2. A fuel cell electrode according to claim 1, wherein the fine particles of a noble metal or a noble metal element-containing alloy are finely dispersed on the inner walls of the fine pores of the porous graphite film having fine continuous pores.

3. A fuel cell electrode according to claim 1, wherein the fine particles of a noble metal or a noble metal element-containing alloy are fine particles composed of a noble metal or a noble metal element-containing alloy supported on carbon fine particles.

4. A fuel cell electrode according to claim 1, wherein the porous graphite film has a crystallinity of 60% or more.

5. A fuel cell electrode according to claim 1, wherein the porous graphite film has a mean pore size of 0.05-10 μm and a porosity of 10-85%.

6. A fuel cell electrode according to claim 1, wherein the porous graphite film has a thickness of 3-100 μm.

7. A fuel cell electrode according to claim 1, wherein the noble metal or noble metal element-containing alloy is supported in a proportion of 0.1-60 mass % in the electrode.

8. A fuel cell electrode according to claim 1, wherein the noble metal is selected from the group consisting of palladium, platinum, rhodium, ruthenium and iridium.

9. A fuel cell electrode characterized in that an ion-conducting electrolyte material is coated on the inner walls of the continuous pores of a fuel cell electrode according to any one of claims 1 to 8.

10. A membrane-electrode assembly comprising a fuel cell electrode according to any one of claims 1 to 8 assembled onto at least one side of the ion-conducting electrolyte material.

11. A membrane-electrode assembly according to claim 10, wherein the ion-conducting electrolyte material is a polymer electrolyte material.

12. A fuel cell having a membrane-electrode assembly according to claim 10 as a constituent element thereof.

13. A fuel cell having a membrane-electrode assembly according to claim 11 as a constituent element thereof.
